(19) United States
(12) Patent Application Publication
(10) Pub. No.: US 2016/0304148 A1
(43) Pub. Date: Oct. 20, 2016

(54) BICYCLE SKID ASSEMBLY FOR TRICK MANEUVERS

(71) Applicant: Ryan G. Hensley, Rocklin, CA (US)

(72) Inventor: Ryan G. Hensley, Rocklin, CA (US)

(21) Appl. No.: 15/096,223

(22) Filed: Apr. 11, 2016

Related U.S. Application Data
(60) Provisional application No. 62/147,918, filed on Apr. 15, 2015.

(51) Int. Cl. B62J 23/00

(52) U.S. Cl. CPC B62J 23/00

(57) ABSTRACT

A slide assembly for sliding a bicycle along a rail with the bicycle oriented approximately orthogonal to the direction of travel along the rail includes clamps and support arms to connect a slide plate, known as a skid, below the bottom bracket of the frame. The skid provides a surface upon which the bicycle may slide along a rail. The assembly positions the skid at or nearly in line with a vertical axis extending through the center of mass of the bicycle, sufficiently apart from the rear wheel, sprocket, chain and pedal crank to avoid interference therewith.

### RELATED APPLICATION

This application is a nonprovisional of and claims the benefit of priority of U.S. provisional application 62/147,918 filed Apr. 9, 2015, the entire contents of which are incorporated herein by this reference.

### FIELD OF THE INVENTION

This invention relates generally to bicycles, and, more particularly, to a slide assembly for sliding a bicycle along a rail with the bicycle oriented approximately orthogonal to the direction of travel along the rail.

### BACKGROUND

The stunt of “grinding” or sliding is commonly performed on bicycles, particularly motocross bicycles (BMX bicycles). Heretofore, to perform this stunt, a rider must equip the bicycle with pegs. A cylindrical peg is secured laterally extending from each of the wheel axles a short distance of about five to six inches. With the bicycle in motion, the rider directs the bicycle so as to slide the pegs along an elongated rail (e.g., a handrail) of generally circular configuration. After traversing the length of the rail the bicycle leaves the rail and returns to the ground.

A problem with grinding using pegs is that the center of mass of the combined bicycle and rider is apart from the center of rail. Thus, the rider experiences a torque that must be counteracted by shifting weight. This destabilizes the rider and bicycle.

Another problem with pegs is that they extend substantially from the side of the bicycle. Pegs may catch on nearby objects causing a rider to fall.

A shortcoming with pegs is that they allow only movement of the bicycle parallel to the rail. Pegs do not allow the bicycle to slide in an orthogonal orientation.

The invention is directed to overcoming one or more of the problems and solving one or more of the needs as set forth above.

### SUMMARY OF THE INVENTION

To solve one or more of the problems set forth above, in an exemplary implementation of the invention, a slide assembly for sliding a bicycle along a rail with the bicycle oriented approximately orthogonal to the direction of travel along the rail is provided. The assembly includes clamps and support arms to connect a slide plate, known as a skid, below the bottom bracket of the frame. The skid provides a surface upon which the bicycle may slide along a rail (e.g., a handrail) with the bicycle oriented orthogonal to the rail. The assembly positions the skid at or nearly in line with a vertical axis extending through the center of mass of the bicycle, sufficiently apart from the rear wheel, sprocket, chain and pedal crank to avoid interference therewith.

An exemplary slide assembly according to principles of the invention includes a fore clamp that grips the down tube of a bicycle frame, and at least one clamp that grips one or both chainstays. The slide assembly also includes a skid (aka slide plate) having an upwardly curved or angled leading edge and a downwardly curved or angled trailing edge, with a planar or arcuate intermediate segment extending from the leading edge to the trailing edge. One or more structural support members connect the fore and aft clamps to the slide plate. The slide plate is positioned below the bottom bracket of the frame and extends downwardly past the bottom of the sprocket, in alignment with the frame plane, between the crank arms, but not to the ground. The leading edge of the slide plate is below the fore clamp. The trailing edge of the slide plate is below the aft clamp.

In one exemplary embodiment, a bicycle frame includes a head tube having a top end and a bottom end, and a seat tube having a top end and a bottom end and being spaced apart from and generally parallel to the head tube, a crank bracket at the bottom end of the seat tube, a down tube extending forward at a first angle from the crank bracket at the bottom end of the seat tube to the bottom end of the head tube, and a pair of spaced apart chainstay tubes extending backward at a second angle from the crank bracket. The seat tube, head tube and down tube lie in a frame plane. A bicycle skid assembly for the frame includes a slide plate with a leading edge, an intermediate portion, and a trailing edge. The trailing edge is at least 4 inches apart from the leading edge. The intermediate portion includes a generally planar segment orthogonal to the frame plane. A fore attachment connects to the down tube of the bicycle frame. An aft attachment connects to at least one of the pair of chainstay tubes. At least one structural member connects the fore attachment to the slide plate and connects the aft attachment to the slide plate and positions the slide plate below the crank bracket. The leading edge of the slide plate may include an upwardly curved portion or an upwardly angled portion. The trailing edge of the slide plate may include a downwardly curved portion or a downwardly angled portion.

A sprocket is rotatably connected to the crank bracket. The sprocket has a sprocket diameter defining a bottom of the sprocket. The at least one structural member positions the slide plate below the bottom of the sprocket.

The fore attachment may comprise a down tube clamp. The down tube clamp has a first down tube clamp bracket and a second down tube clamp bracket and at least one down tube clamp mechanical fastener for urging the first down tube clamp bracket towards the second down tube clamp bracket with a clamped portion of the down tube securely gripped between the first down tube clamp bracket and the second down tube clamp bracket.

The aft attachment may comprise at least one chainstay tube clamp. The at least one chainstay tube clamp has a first chainstay tube clamp bracket and a second chainstay tube clamp bracket and at least one chainstay tube clamp mechanical fastener for urging the first chainstay tube clamp bracket towards the second chainstay tube clamp bracket with a clamped portion of one chainstay tube of the pair of chainstay tubes securely gripped between the first chainstay tube clamp bracket and the second chainstay tube clamp bracket.

Alternatively, the at least one chainstay tube clamp may include a first chainstay tube clamp bracket and a second chainstay tube clamp bracket and at least one chainstay tube clamp mechanical fastener for urging the first chainstay tube clamp bracket towards the second chainstay tube clamp bracket with a clamped portion of each chainstay tube of the pair of chainstay tubes securely gripped between the first chainstay tube clamp bracket and the second chainstay tube clamp bracket.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a plan view of an exemplary slide assembly for a bicycle according to principles of the invention; and

FIG. 2 is a back view of an exemplary slide assembly for a bicycle according to principles of the invention; and

FIG. 3 is a side view of an exemplary slide assembly for a bicycle according to principles of the invention; and

FIG. 4 is a top front perspective view of an exemplary slide assembly for a bicycle according to principles of the invention; and

FIG. 5 is a top back perspective view of an exemplary slide assembly for a bicycle according to principles of the invention; and

FIG. 6 is another top front perspective view of an exemplary slide assembly for a bicycle according to principles of the invention; and

FIG. 7 is a side view of an exemplary slide assembly attached to a bicycle frame according to principles of the invention; and

FIG. 8 is a perspective view of an exemplary slide assembly attached to a bicycle frame according to principles of the invention; and

FIG. 9 is a side view of an exemplary slide assembly attached to a bicycle according to principles of the invention; and

FIG. 10 is a perspective view of an exemplary slide assembly attached to a bicycle according to principles of the invention; and

FIG. 11 is a bottom view of an exemplary slide assembly attached to a bicycle according to principles of the invention; and

FIG. 12 is a side view of an exemplary slide assembly with an optional pad according to principles of the invention; and

FIG. 13 is a perspective view of an exemplary slide assembly with an optional pad according to principles of the invention; and

FIG. 14 is a plan view of another exemplary slide assembly for a bicycle according to principles of the invention; and

FIG. 15 is a side view of the exemplary slide assembly of FIG. 14; and

FIG. 16 is a first perspective view of the exemplary slide assembly of FIG. 14; and

FIG. 17 is a bottom view of the exemplary slide assembly of FIG. 14; and

FIG. 18 is a second perspective view of the exemplary slide assembly of FIG. 14; and

FIG. 19 is a side view of the exemplary slide assembly of FIG. 14 installed on a bicycle frame; and

FIG. 20 is a perspective view of the exemplary slide assembly of FIG. 14 installed on a bicycle frame.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

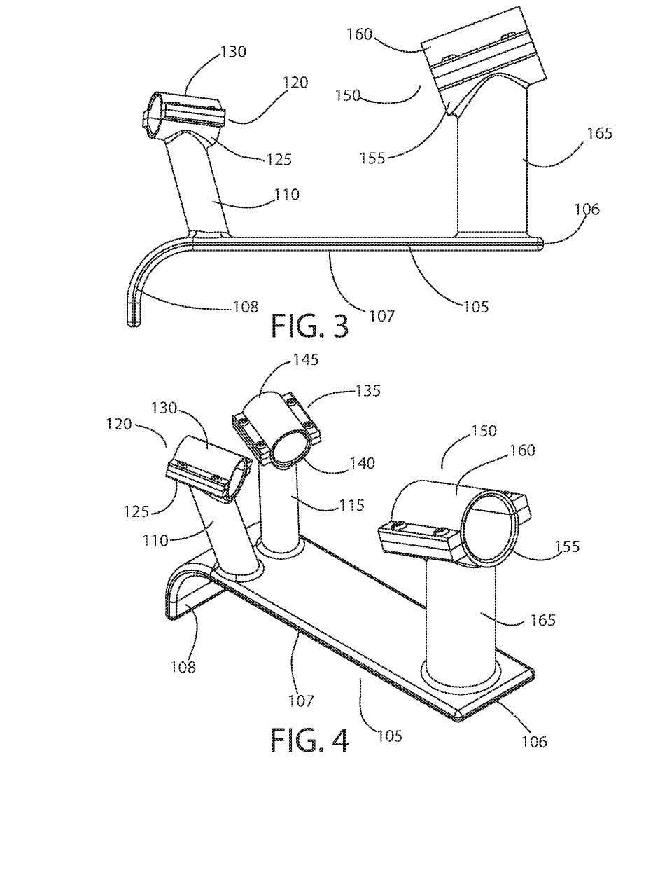

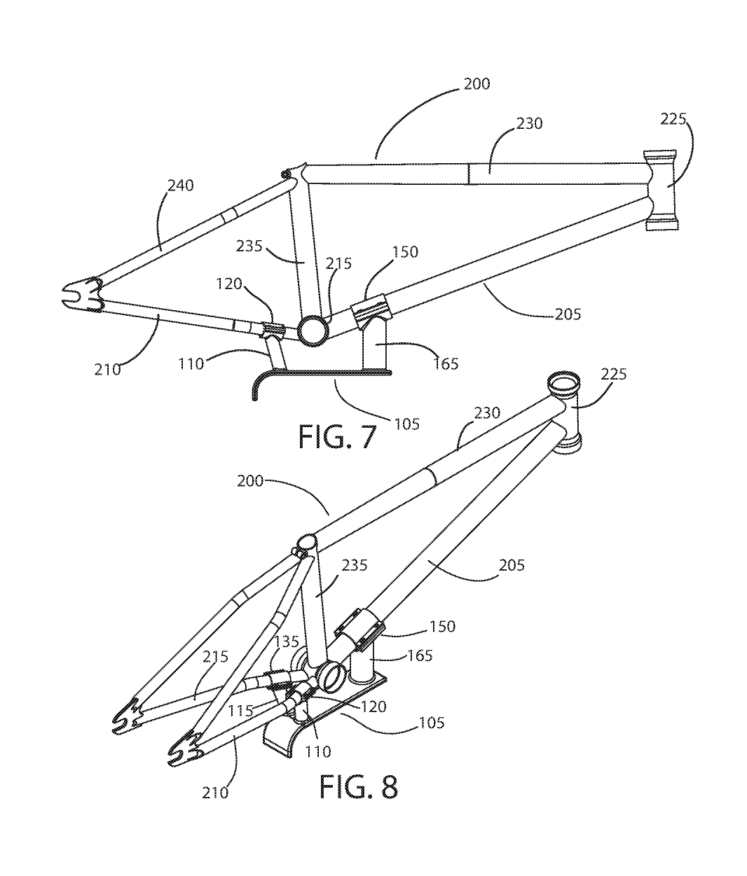

With reference to FIGS. 7, 8, 19 and 20, BMX frames 200 are made of various types of tubular steel, aluminum, alloys and composites. The frame 200 of a BMX bicycle typically includes a top tube 230, a head tube 225, a seat tube 235 and a down tube 205 forming a quadrilateral. Seat stays 240, 245 extends backwardly from the intersection of the seat tube 235 and top tube 230 and converges with right and left chainstays 210, 215, which extend backwardly from a bottom bracket 220. The back end of the down tube 205 and the bottom end of the seat tube 235 intersect with the bottom bracket 220. A sprocket 325 and pedal crank, with left and right crank arms 330, 331, extend from the bottom bracket 220, as shown in FIG. 3.

The top tube 230, a head tube 225, a seat tube 235, down tube 205 and bracket are aligned to lie in a plane, referred to as the frame plane. The frame plane extends through the middle of each of the top tube 230, a head tube 225, a seat tube 235, down tube 205.

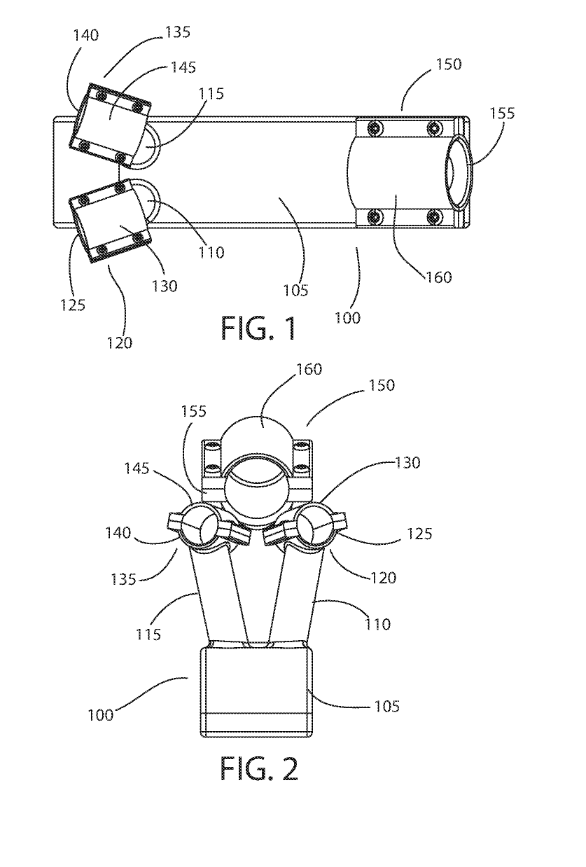

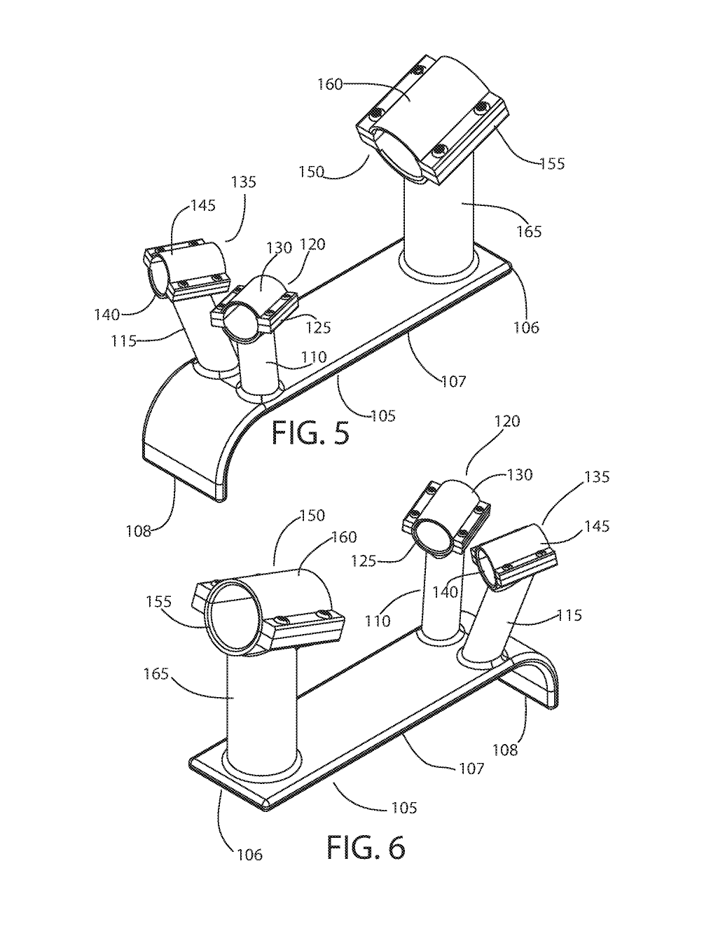

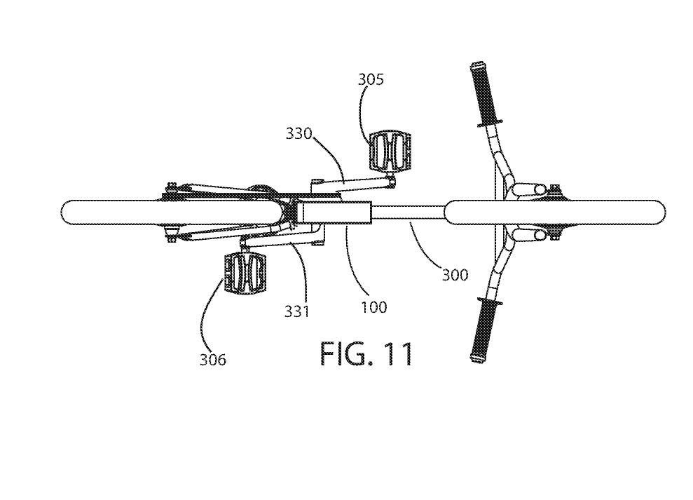

Referring to FIGS. 1-13, various view of an exemplary slide assembly for a BMX bicycle is provided. The assembly includes clamps and support arms to connect a slider plate below the bottom bracket of a frame. The slide plate provides a surface upon which the bicycle may slide along a rail (e.g., a handrail) with the bicycle oriented orthogonal to the rail. The assembly positions the slide plate at or nearly in line with a vertical axis extending through the center of mass of the bicycle, sufficiently apart from the rear wheel, sprocket, chain and pedal crank to avoid interference therewith.

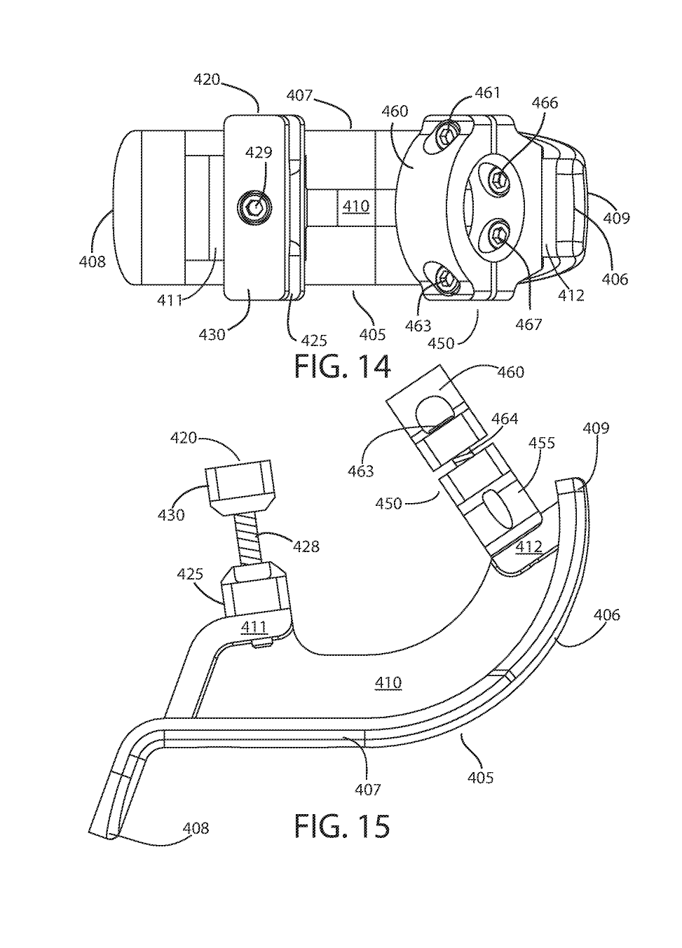

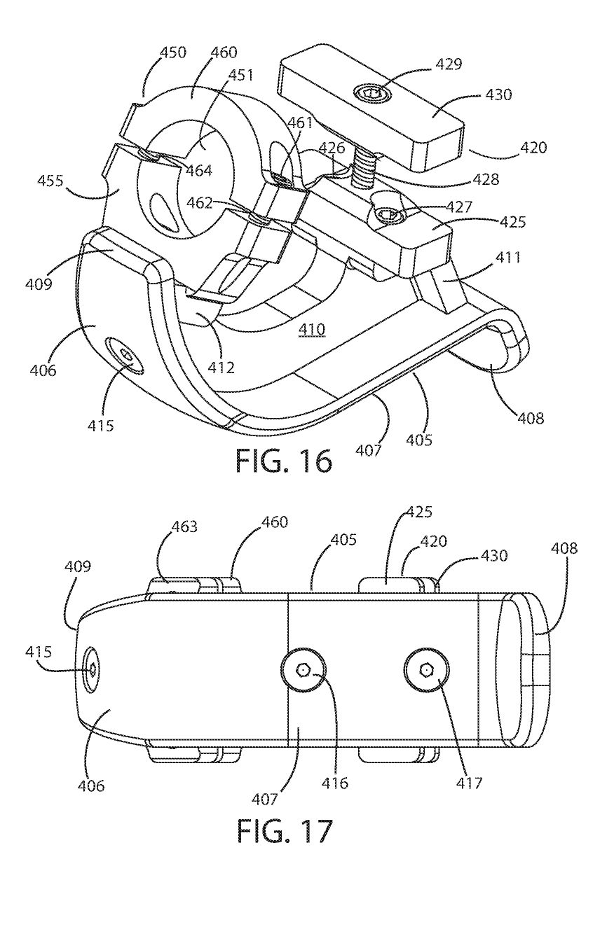

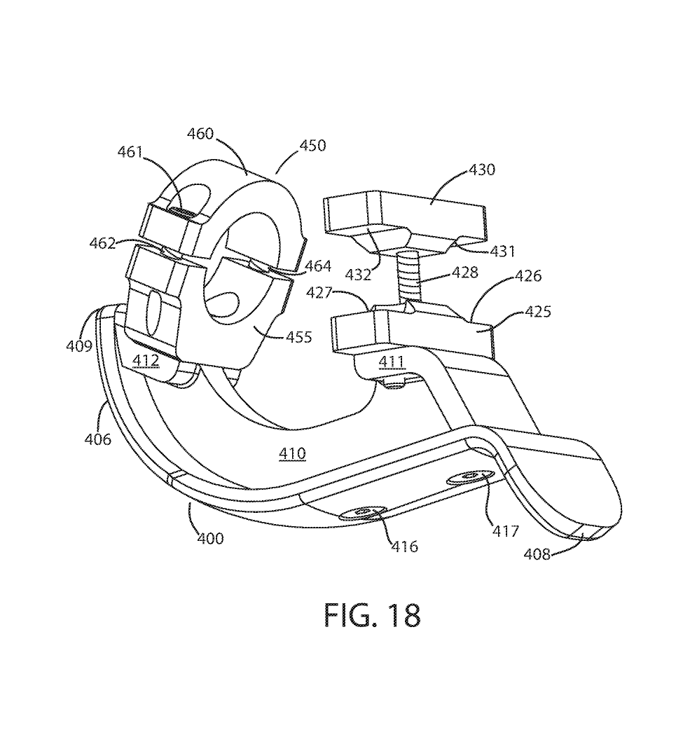

In FIGS. 14-20, an alternative embodiment of the exemplary slide plate is illustrated. In each embodiment an exemplary slide assembly according to principles of the invention includes an attachment to the down tube, such as a fore clamp that grips the down tube, of a bicycle frame, and an attachment to at least one chainstay, preferably both chainstays, such as at least one aft clamp that grips one or both chainstays. The slide assembly also includes a skid (aka slide plate) having an upwardly curved or angled leading edge and a downwardly curved or angled trailing edge, with a planar or arcuate intermediate segment extending from the leading edge to the trailing edge. One or more structural support members connect the fore and aft attachments (e.g., clamps) to the slide plate. The slide plate is positioned below the bottom bracket of the frame and extends downwardly past the bottom of the sprocket, in alignment with the frame plane, between the crank arms, but not to the ground. The leading edge of the slide plate is below the fore attachment (e.g., fore clamp). The trailing edge of the slide plate is below the aft attachment (e.g., aft clamp). In an OEM embodiment, the slide assembly may be formed with the plane, using one or more support members to attach the slide plate to the down tube and chainstays below the bracket, using, for example, welded attachments.

In the embodiment of FIGS. 1 through 6, a down tube clamp 150 (aka fore clamp) couples the assembly 100 to the down tube of a bicycle frame, near the bottom bracket of the frame to which the pedal crank and sprocket attach. The down tube clamp 150 is angled relative to the horizontal at about the same angle as the down tube 205 of the frame 200. The angle of the clamp 150 may be fixed or adjustable. The clamp 150 includes a top bracket 160 that is attached to a bottom bracket 155 using mechanical fasteners (e.g., screws or nuts and bolts). These brackets 155, 160 surround (entirely or partially) and grip the engaged portion of the down tube 205.

A pair of chainstay clamps 120, 135 (aka aft clamps) couple the assembly 100 to the right and left chainstay tubes of the bicycle frame. Each chainstay clamp 125, 130 is angled relative to the horizontal and the vertical at about the same angle as the correspondingly engaged chainstay tube 210, 215. Each chainstay clamp 120, 135 includes a top bracket 130, 145 that is attached to a bottom bracket 125, 140, using mechanical fasteners (e.g., screws or nuts and bolts). These brackets 125, 130 and 140, 145 surround (entirely or partially) and grip the engaged portion of the respective chainstay tube.

In one embodiment, a separate clamp 120, 135 is provided for each chainstay tube 210, 215. In another embodiment, a single clamp 420 (FIG. 15) is provided for both chainstay tubes 210, 215. In the single clamp embodiment, the chainstay tubes 210, 215 may be sandwiched between lower and upper clamping members 425, 430, brought into clamping configuration by tightening a screl 429 with a threaded shaft 428.

The invention is not limited to the particular clamps 120, 135, 150, 420, 450 shown in the figures. Rather, other clamps and attachment mechanisms may be utilized within the scope of the invention. By way of example and not limitation, each arm 110, 115, 165 may be coupled to the frame using a flange mechanically fastened or welded to the frame. Alternatively, each arm 110, 115, 165 may be welded to the frame, such as during OEM manufacturing. As another alternative, support 410 and mountings 411 and 412 may be flanged and mechanically attached or welded to the frame 200.

In the embodiment of FIGS. 1 through 6, a support arm 110, 115, 165 couples each clamp 120, 135, 150 to the skid 105. The support arms 110, 115, 165 are structural supports with sufficient strength to support the skid 105 during maneuvers. Each support arm 110, 115, 165 may comprise a solid or tubular shaft of aluminum, steel, an alloy, plastic or composite. The support arms 110, 115, 165 are sized to position the skid 105 at a height above the ground that is less than the height of the bottom of the sprocket. The support arms 110, 115, 165 position the skid 105 beneath the frame, between the right and left pedal cranks. The support arms 110, 115, 165 position the skid 105 between the tires 315, 320. The support arms 110, 115, 165 position the skid beneath the bottom bracket 220 of the frame 200 to which the pedal crank 330, 331, pedals 305, 306 and sprocket 325 attach. The length of the support arms 110, 115, 165 may vary depending upon the particular frame configuration and location of the clamps 120, 135, 150. In a preferred implementation the arms 110, 115, 165, are long enough to position the slide plate 105 at a height that is one inch or more below the height of the bottom of the sprocket 325, but above the ground (i.e., not to the bottom of the tires).

The exemplary skid 105 includes a generally planar base 107, a leading edge 106 and a trailing edge 108. The leading edge is curved, filleted or chamfered upwardly to facilitate passage of the skid 105 onto a rail. The trailing edge 108 is angled or curved downwardly. The downward portion of the trailing edge 108 prevents sliding off the back end of the skid 105 and contacting the rear tire.

The invention is not limited to the particular configuration of the skid 105 shown in the figures. Rather, other skid configurations, arcuate, planar, angled and otherwise shaped may be utilized within the scope of the invention.

In FIGS. 7 and 8, the assembly 100 is illustrated attached to a BMX frame 200. The down tube clamp 150 clamps the down tube 205. The chainstay clamps 120, 135 clamp the right 210 and left 215 chainstay tubes of the frame 200. The arms 110, 115, 165 position the skid 105 below the bottom bracket 220 of the frame 200.

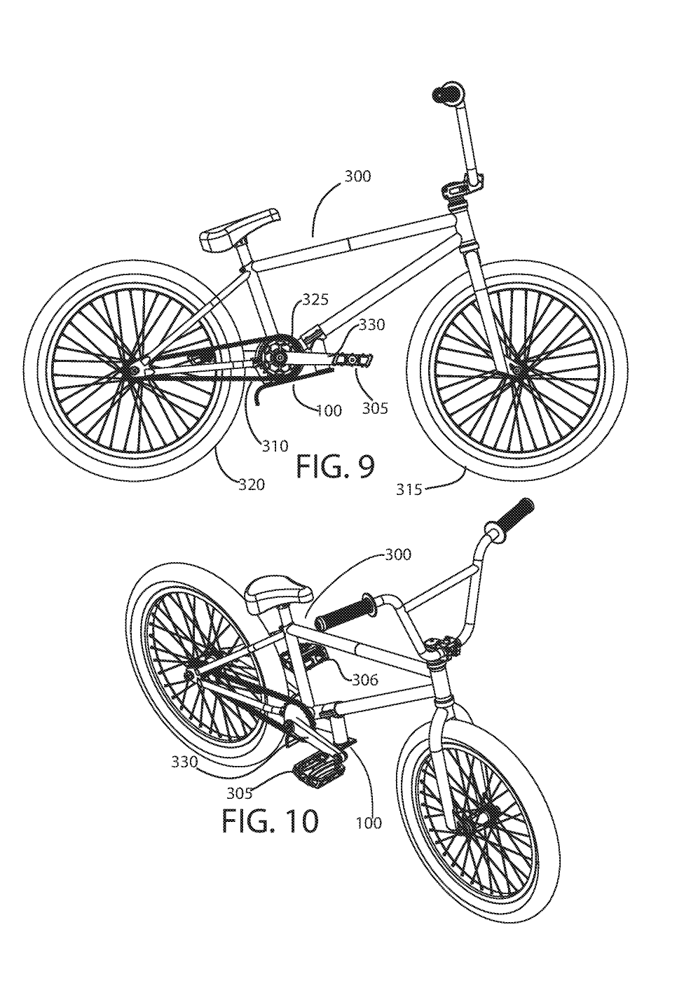

In FIGS. 9 through 11, the assembly 100 is illustrated mounted to a BMX bicycle 300. The assembly is mounted between the tires 315, 320, below the sprocket 325 and clear of the pedals 305, 306 and crank arms 330, 331. Thus, the assembly 100 does not interfere with use of the bicycle, including normal use and trick maneuvers.

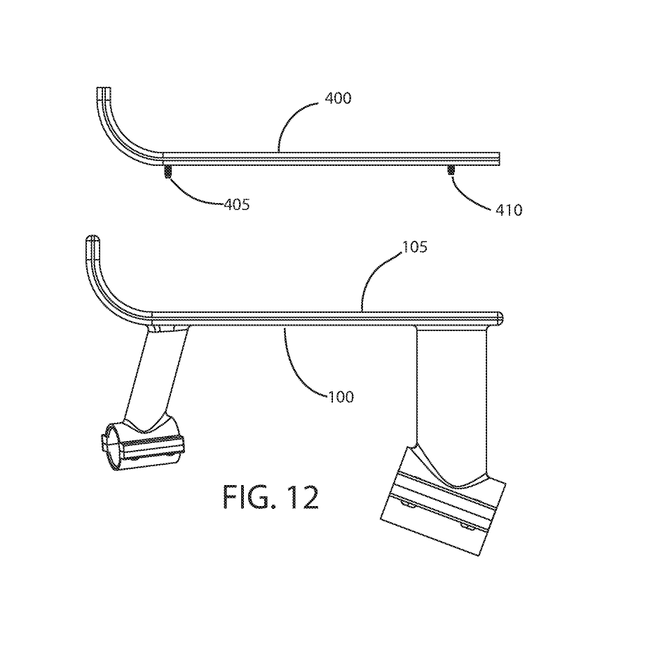

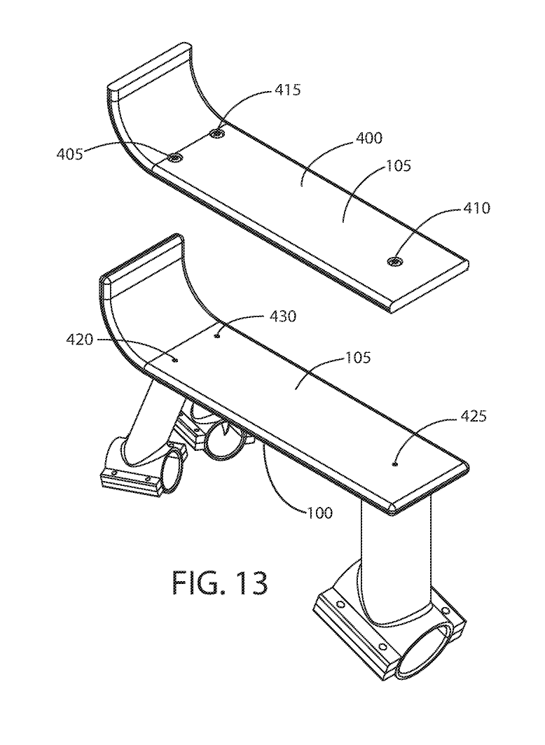

In FIGS. 12 and 13 an embodiment with an optional replaceable pad 400 is shown. The pad 400 overlays the skid 105. The pad attaches using mechanical fasteners, such as screws 405-415 threadedly engaging threaded holes 420-430 in the skid 105. The pad 400 may provide a friction reducing or friction increasing surface. The pad 400 may be textured or contoured to facilitate or guide sliding motion. The pad 400 may protect the skid 105 or a rail from marring. The pad 400 may reduce scraping noises as the skid 105 slides along a rail. The pad may be replaceable and disposable.

Referring now to FIGS. 14-20, an embodiment of an exemplary slide assembly according to principles of the invention includes an attachment to the down tube, such as a fore clamp 450 that grips the down tube 205, of a bicycle frame 200, and an attachment to at least one chainstay, preferably both chainstays, such as at least one aft clamp 420 that grips one or both chainstays 210, 215. The slide assembly also includes a skid (aka slide plate) 405 having an upwardly curved or angled portion 406 terminating at a leading edge 409, a downwardly curved or angled trailing edge 408, with a planar or arcuate intermediate segment 407 extending between the leading edge 409 and trailing edge 408. One or more structural support members 410, 411, 412 connect the fore and aft attachments (e.g., clamps 420, 450) to the slide plate 405. The slide plate 405 is positioned below the bottom bracket of the frame and extends downwardly past the bottom of the sprocket 325, in alignment with the frame plane, between the crank arms 330, 331, but not to the ground. The leading edge 409 of the slide plate 405 is below and forward of the fore attachment (e.g., fore clamp 450). The trailing edge 408 of the slide plate 405 is below and behind the aft attachment (e.g., aft clamp 420). In an OEM embodiment, one or more support members may attach the slide plate to the down tube and chainstays below the bracket, using, for example, welded attachments.

In the embodiment 400 of FIGS. 14 through 20, a down tube clamp 450 (aka fore clamp) couples the assembly to the down tube 205 of a bicycle frame, near the bottom bracket 220 of the frame to which the pedal crank arms 330, 331 and sprocket 325 attach. The down tube clamp 450 is angled relative to the horizontal at about the same angle as the down tube 205 of the frame 200. The angle of the clamp 450 may be fixed or adjustable. The clamp 450 includes a top bracket 460 that is attached to a bottom bracket 455 using mechanical fasteners (e.g., screws or nuts and bolts 461, 463, with threaded shanks 462, 464). These brackets 455, 460 surround (entirely or partially) and securely grip the engaged portion of the down tube 205 when the brackets are urged together using mechanical fasteners (e.g., screws or nuts and bolts 461, 463, with threaded shanks 462, 464).

The fore clamp 450 is attached to a fore mounting base 412, with mechanical fasteners (e.g., screws or nuts and bolts 466, 467). The fore mounting base 412 is attached to the rib 410, projecting upwardly from the slide plate 405. The fore mounting base 412 may be welded to, mechanically fastened to, or integrally formed with the rib 410. The fore mounting base 412 provides a flanged surface to which the fore clamp 450 can be attached. The rib 410, in combination with fore mounting base provides structural attachment, orientation (e.g., angle) and spacing to properly position the fore clamp 450 for attachment to the down tube 205.

A chainstay clamp 420 (aka aft clamps) couples the assembly to the right and left chainstay tubes of the bicycle frame. The chainstay clamp 420 is angled relative to the horizontal and the vertical at about the same angle as the correspondingly engaged chainstay tube 210, 215. The chainstay clamp 420 includes a top bracket 430 that is attached to a bottom bracket 425 using mechanical fasteners (e.g., screws or nuts and bolts 428, 429). These brackets 425, 430 grip an engaged portion of each chainstay tube. Together the top bracket 430, bottom bracket 425 and threaded connection 428 form an I-shaped clamp. When a portion of pair of chainstays 210, 215 are sandwiched between the brackets 425, 430 and the threaded connection 428 is tightened, bringing the brackets 425, 430 closer together by turning the screw head 429, the brackets 425, 430 eventually clamp (i.e., securely grip) the engaged portion of pair of chainstays 210, 215. The brackets 420, 425 may have contours 426, 427, 431, 432 to receive portions of the engaged chainstays 210, 215 and resist rotation of the clamp 420 when the chainstays 210, 215 are gripped by the clamp 420.

The aft clamp 420 is attached to an aft mounting base 411, with mechanical fasteners (e.g., screws or nuts and bolts 426, 427). The aft mounting base 411 is attached to the rib 410, projecting upwardly from the slide plate 405. The aft mounting base 411 may be welded to, mechanically fastened to, or integrally formed with the rib 410. The aft mounting base 411 provides a flanged surface to which the aft clamp 420 can be attached. The rib 410, in combination with aft mounting base 412, provides structural attachment, orientation (e.g., angulation) and spacing to properly position the aft clamp 420 for attachment to the chainstays 210, 215.

The arms 110, 115, 165, rib 410 and bases 411, 412 provide a structural framework that couples the clamps 120, 140, 150, 420, 450 to the slide plate 205, 405. The structural framework may be formed of solid and/or tubular structural connections. In each case, the structural framework provides for proper positioning and orientation of the clamps 120, 140, 150, 420, 450 relative to the slide plate 205, 405, as well as structural integrity to maintain such positioning and orientation during normal use.

The rib 410 and bases 411, 412 position the skid 405 (i.e., slide plate) beneath the frame, between the right and left pedal crank arms 330, 331; between the tires 315, 320; beneath the bottom bracket 220 of the frame 200 to which the pedal crank arms 330, 331, pedals 305, 306 and sprocket 325 attach; with the slide plate 405 at a height that is one inch or more below the height of the bottom of the sprocket 325, but above the ground (i.e., not to the bottom of the tires).

The exemplary skid 405 includes a generally planar base 407, a curved portion 406 terminating at a leading edge 409 and a trailing edge 408. The leading edge is curved, filleted or chamfered upwardly to facilitate passage of the skid 405 onto a rail. The trailing edge 408 is angled or curved downwardly. The downward portion of the trailing edge 408 prevents sliding off the back end of the skid 405 and contacting the rear tire.

The invention is not limited to the particular configuration of the skid 105 shown in the figures. Rather, other skid configurations, arcuate, planar, angled and otherwise shaped may be utilized within the scope of the invention.

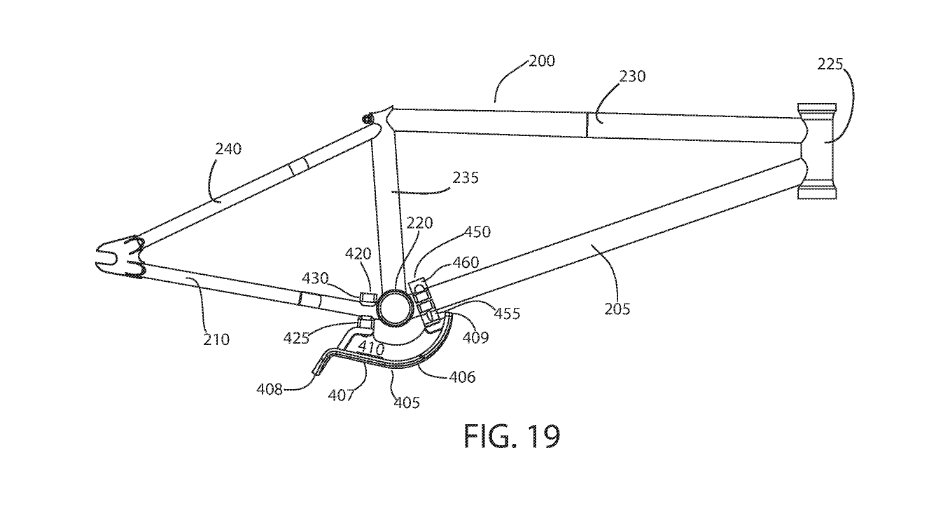

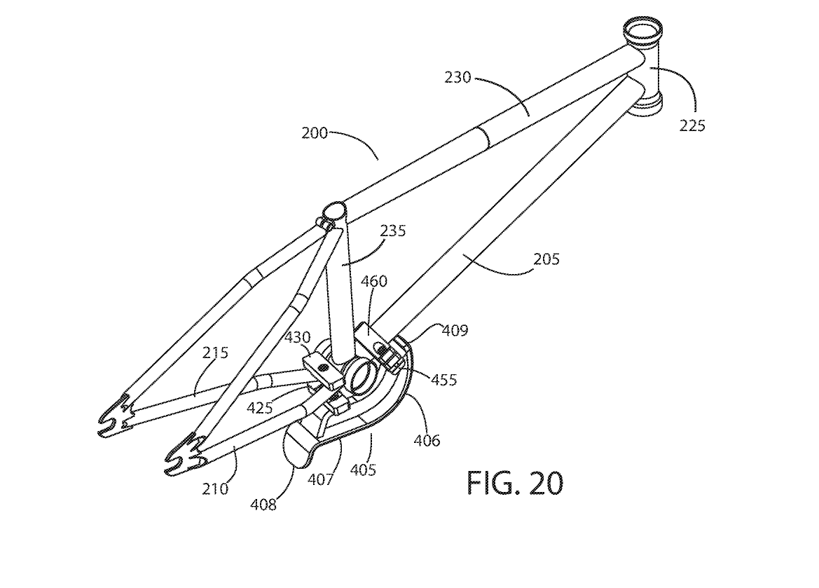

In FIGS. 19 and 20, the assembly 400 is illustrated attached to a BMX frame 200. The down tube clamp 450 clamps the down tube 205. The chainstay clamp 420 clamps the right 210 and left 215 chainstay tubes of the frame 200. The support framework comprised of rib 410 and bases 411, 412 position the skid 45 below the bottom bracket 220 of the frame 200.

In sum, in one exemplary embodiment, a bicycle frame includes a head tube having a top end and a bottom end, and a seat tube having a top end and a bottom end and being spaced apart from and generally parallel to the head tube, a crank bracket at the bottom end of the seat tube, a down tube extending forward at a first angle from the crank bracket at the bottom end of the seat tube to the bottom end of the head tube, and a pair of spaced apart chainstay tubes extending backward at a second angle from the crank bracket. The seat tube, head tube and down tube lie in a frame plane. A bicycle skid assembly for the frame includes a slide plate with a leading edge, an intermediate portion, and a trailing edge. The trailing edge is at least 4 inches apart from the leading edge. The intermediate portion includes a generally planar segment orthogonal to the frame plane. A fore attachment connects to the down tube of the bicycle frame. An aft attachment connects to at least one of the pair of chainstay tubes. At least one structural member connects the fore attachment to the slide plate and connects the aft attachment to the slide plate and positions the slide plate below the crank bracket. The leading edge of the slide plate may include an upwardly curved portion or an upwardly angled portion. The trailing edge of the slide plate may include a downwardly curved portion or a downwardly angled portion.

A sprocket is rotatably connected to the crank bracket. The sprocket has a sprocket diameter defining a bottom of the sprocket. The at least one structural member positions the slide plate below the bottom of the sprocket.

The fore attachment may comprise a down tube clamp. The down tube clamp has a first down tube clamp bracket and a second down tube clamp bracket and at least one down tube clamp mechanical fastener for urging the first down tube clamp bracket towards the second down tube clamp bracket with a clamped portion of the down tube securely gripped between the first down tube clamp bracket and the second down tube clamp bracket.

The aft attachment may comprise at least one chainstay tube clamp. The at least one chainstay tube clamp has a first chainstay tube clamp bracket and a second chainstay tube clamp bracket and at least one chainstay tube clamp mechanical fastener for urging the first chainstay tube clamp bracket towards the second chainstay tube clamp bracket with a clamped portion of one chainstay tube of the pair of chainstay tubes securely gripped between the first chainstay tube clamp bracket and the second chainstay tube clamp bracket.

Alternatively, the at least one chainstay tube clamp may include a first chainstay tube clamp bracket and a second chainstay tube clamp bracket and at least one chainstay tube clamp mechanical fastener for urging the first chainstay tube clamp bracket towards the second chainstay tube clamp bracket with a clamped portion of each chainstay tube of the pair of chainstay tubes securely gripped between the first chainstay tube clamp bracket and the second chainstay tube clamp bracket.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A bicycle skid assembly for attachment to a bicycle frame, the bicycle frame including a head tube having a top end and a bottom end, and a seat tube having a top end and a bottom end and being spaced apart from and generally parallel to the head tube, a crank bracket at the bottom end of the seat tube, a down tube extending forward at a first angle from the the crank bracket at the bottom end of the seat tube to the bottom end of the head tube, and a pair of spaced apart chainstay tubes extending backward at a second angle from the crank bracket, the seat tube, head tube and down tube being in a frame plane, said bicycle skid assembly comprising:
a slide plate, the slide plate including a leading edge, an intermediate portion, and a trailing edge, a distance from the leading edge and trailing edge being at least four inches, the intermediate portion including a generally planar segment orthogonal to the frame plane;
a fore attachment, the fore attachment connecting to the down tube of the bicycle frame;
an aft attachment, the aft attachment connecting to at least one of the pair of chainstay tubes; and
at least one structural member, the at least one structural member connecting the fore attachment to the slide plate and connecting the aft attachment to the slide plate and positioning the slide plate below the crank bracket.

2. The bicycle skid assembly according to claim 1, a sprocket rotatably connected to the crank bracket, said sprocket having a sprocket diameter defining a bottom of the sprocket, and the at least one structural member positioning the slide plate below the bottom of the sprocket.

3. The bicycle skid assembly according to claim 2, said fore attachment comprising a down tube clamp.

4. The bicycle skid assembly according to claim 3, said down tube clamp comprising a first down tube clamp bracket and a second down tube clamp bracket and at least one down tube clamp mechanical fastener for urging the first down tube clamp bracket towards the second down tube clamp bracket with a clamped portion of the down tube securely gripped between the first down tube clamp bracket and the second down tube clamp bracket.

5. The bicycle skid assembly according to claim 4, said aft attachment comprising at least one chainstay tube clamp.

6. The bicycle skid assembly according to claim 5, said at least one chainstay tube clamp comprising a first chainstay tube clamp bracket and a second chainstay tube clamp bracket and at least one chainstay tube clamp mechanical fastener for urging the first chainstay tube clamp bracket towards the second chainstay tube clamp bracket with a clamped portion of a chainstay tube of the pair of chainstay tubes securely gripped between the first chainstay tube clamp bracket and the second chainstay tube clamp bracket.

7. The bicycle skid assembly according to claim 5, said at least one chainstay tube clamp comprising a first chainstay tube clamp bracket and a second chainstay tube clamp bracket and at least one chainstay tube clamp mechanical fastener for urging the first chainstay tube clamp bracket towards the second chainstay tube clamp bracket with a clamped portion of each chainstay tube of the pair of chainstay tubes securely gripped between the first chainstay tube clamp bracket and the second chainstay tube clamp bracket.

8. The bicycle skid assembly according to claim 1, the leading edge of the slide plate including an upwardly curved portion.

9. The bicycle skid assembly according to claim 1, the leading edge of the slide plate including an upwardly angled portion.

10. The bicycle skid assembly according to claim 1, the trailing edge of the slide plate including an downwardly curved portion.

11. The bicycle skid assembly according to claim 1, the trailing edge of the slide plate including an downwardly angled portion.

12. A bicycle frame with a bicycle skid assembly, the bicycle frame comprising:
a head tube having a top end and a bottom end, and a seat tube having a top end and a bottom end and being spaced apart from and generally parallel to the head tube, a crank bracket at the bottom end of the seat tube, a down tube extending forward at a first angle from the the crank bracket at the bottom end of the seat tube to the bottom end of the head tube, and a pair of spaced apart chainstay tubes extending backward at a second angle from the crank bracket, the seat tube, head tube and down tube being in a frame plane, a sprocket rotatably connected to the crank bracket, said sprocket having a sprocket diameter defining a bottom of the sprocket;
said bicycle skid assembly comprising:
a slide plate, the slide plate including a leading edge, an intermediate portion, and a trailing edge, a distance from the leading edge and trailing edge being at least four inches, the intermediate portion including a general planar segment orthogonal to the frame plane;
a fore attachment, the fore attachment connecting to the down tube of the bicycle frame;
an aft attachment, the aft attachment connecting to at least one of the pair of chainstay tubes; and
at least one structural member, the at least one structural member connecting the fore attachment to the slide plate and connecting the aft attachment to the slide plate and positioning the slide plate below the crank bracket and below the bottom of the sprocket.

13. The bicycle skid assembly according to claim 12, said fore attachment comprising a first weld of the at least one structural member to the down tube.

14. The bicycle skid assembly according to claim 13, said aft attachment comprising a second weld of the at least one chainstay tube of the pair of spaced apart chainstay tubes.

15. The bicycle skid assembly according to claim 12, said fore attachment comprising a down tube clamp, said down tube clamp comprising a first down tube clamp bracket and a second down tube clamp bracket and at least one down tube clamp mechanical fastener for urging the first down tube clamp bracket towards the second down tube clamp bracket with a clamped portion of the down tube securely gripped between the first down tube clamp bracket and the second down tube clamp bracket.

16. The bicycle skid assembly according to claim 15, said aft attachment comprising at least one chainstay tube clamp, the at least one chainstay tube clamp comprising a first chainstay tube clamp bracket and a second chainstay tube clamp bracket and at least one chainstay tube clamp mechanical fastener for urging the first chainstay tube clamp bracket towards the second chainstay tube clamp bracket with a clamped portion of a chainstay tube of the pair of chainstay tubes securely gripped between the first chainstay tube clamp bracket and the second chainstay tube clamp bracket.

17. The bicycle skid assembly according to claim 15, said aft attachment comprising at least one chainstay tube clamp, the at least one chainstay tube clamp comprising a first chainstay tube clamp bracket and a second chainstay tube clamp bracket and at least one chainstay tube clamp mechanical fastener for urging the first chainstay tube clamp bracket towards the second chainstay tube clamp bracket with a clamped portion of each chainstay tube of the pair of chainstay tubes securely gripped between the first chainstay tube clamp bracket and the second chainstay tube clamp bracket.

18. The bicycle skid assembly according to claim 15, the leading edge of the slide plate including an upwardly curved portion and the trailing edge of the slide plate including an downwardly angled portion.

19. The bicycle skid assembly according to claim 15, the leading edge of the slide plate including an upwardly angled portion and the trailing edge of the slide plate including an downwardly angled portion.

20. A bicycle skid assembly comprising:
a slide plate, the slide plate including a leading edge, an intermediate portion, and a trailing edge, a distance from the leading edge and trailing edge being at least four inches, the intermediate portion including a general planar segment orthogonal to the frame plane, the leading edge of the slide plate including an upwardly curved portion and the trailing edge of the slide plate including an downwardly angled portion;
a fore attachment, the fore attachment comprising a fore clamp having opposed first and second clamping brackets;
an aft attachment, the aft attachment comprising an aft clamp having opposed third and fourth clamping brackets; and
at least one structural member, the at least one structural member connecting the fore attachment to the slide plate and connecting the aft attachment to the slide plate and positioning the intermediate portion of the slide plate at least 2.5 inches below the fore attachment and aft attachment.
